(19) United States
(12) Patent Application Publication
(10) Pub. No.: US 2026/0311473 A1
(43) Pub. Date: Oct. 8, 2026

(54) IMAGE PROCESSING METHOD AND APPARATUS, DEVICE, STORAGE MEDIUM, AND COMPUTER PROGRAM PRODUCT

(71) Applicant: THE HONG KONG UNIVERSITY OF SCIENCE AND TECHNOLOGY (GUANGZHOU), Guangzhou (CN)

(72) Inventors: Hui Xiong, Guangzhou (CN); Yunfan Lu, Guangzhou (CN); Guoqiang Liang, Guangzhou (CN)

(21) Appl. No.: 19/466,280

(22) Filed: Jan. 31, 2026

Related U.S. Application Data
(63) Continuation-in-part of application No. PCT/CN2025/098672, filed on May 30, 2025.

(30) Foreign Application Priority Data
May 30, 2024 (CN) 202410692324.X

(51) Int. Cl. G06V 10/82; G06N 3/0464; G06N 3/08; G06V 10/62; G06V 10/77

(52) U.S. Cl. CPC G06V 10/82; G06N 3/0464; G06N 3/08; G06V 10/62; G06V 10/7715

(57) ABSTRACT

Provided are an image processing method and apparatus, a device, a storage medium, and a computer program product. The method includes: obtaining a rolling shutter (RS) frame acquired by an event camera and event data corresponding to the RS frame; encoding the RS frame and the event data through an encoding unit of an image processing model to obtain spatial-temporal implicit representation (STIR) data corresponding to the RS frame; embedding an exposure time of a global shutter (GS) frame corresponding to the RS frame into the STIR data through a time embedding unit of the image processing model to obtain a temporal tensor corresponding to the RS frame; and decoding the temporal tensor corresponding to the RS frame and the STIR data corresponding to the RS frame pixel by pixel through a decoding unit of the image processing model to generate the GS frame.

### CROSS REFERENCE TO RELATED APPLICATION

This application is a continuation-in-part of International Patent Application No. PCT/CN2025/098672, filed on May 30, 2025. This application claims priority to Chinese Patent Application No. 202410692324.X, filed with the China National Intellectual Property Administration (CNIPA) on May 30, 2024 and entitled “IMAGE PROCESSING METHOD AND APPARATUS, DEVICE, STORAGE MEDIUM, AND COMPUTER PROGRAM PRODUCT”. Both of the foregoing applications are incorporated herein by reference in their entireties.

### TECHNICAL FIELD

This application belongs to the field of computer vision, and in particular, relates to an image processing method and apparatus, a device, a storage medium, and a computer program product.

### BACKGROUND

In the prior art, a consumer-grade camera based on a complementary metal-oxide-semiconductor (CMOS) sensor usually employs a rolling shutter (RS) mechanism. However, in a fast-moving large-scale motion scene, a frame captured by the consumer-grade camera based on the CMOS sensor often suffers from RS frame distortion and blur. To improve clarity of an image captured by the camera, a clear global shutter (GS) frame at a high frame rate need to be recovered from a blurred RS frame. The clear GS frame is usually recovered from the blurred RS frame by performing correction, deblurring, and frame interpolation on the RS frame.

However, in the prior art, the correction, deblurring, and frame interpolation performed on the RS frame are usually taken as independent tasks, and cascaded through existing image enhancement networks. This approach increases cumulative errors and noticeable artifacts, thus reducing clarity of the recovered GS frames.

### SUMMARY

The embodiments of this application provide an image processing method and apparatus, a device, a storage medium, and a computer program product, which can improve clarity of GS frames recovered from an RS frame.

According to a first aspect, an embodiment of this application provides an image processing method. The method includes: obtaining an RS frame acquired by an event camera and event data corresponding to the RS frame; encoding the RS frame and the event data through an encoding unit of an image processing model to obtain spatial-temporal implicit representation (STIR) data corresponding to the RS frame; embedding an exposure time of a GS frame corresponding to the RS frame into the STIR data through a time embedding unit of the image processing model to obtain a temporal tensor corresponding to the RS frame; and decoding the temporal tensor corresponding to the RS frame and the STIR data corresponding to the RS frame pixel by pixel through a decoding unit of the image processing model to generate the GS frame.

According to a second aspect, an embodiment of this application provides an image processing apparatus. The apparatus includes: a data obtaining module configured to obtain an RS frame acquired by an event camera and event data corresponding to the RS frame; an encoding module configured to encode the RS frame and the event data through an encoding unit of an image processing model to obtain STIR data corresponding to the RS frame; a data embedding module configured to embed an exposure time of a GS frame corresponding to the RS frame into the STIR data through a time embedding unit of the image processing model to obtain a temporal tensor corresponding to the RS frame; and a decoding module configured to decode the temporal tensor corresponding to the RS frame and the STIR data corresponding to the RS frame pixel by pixel through a decoding unit of the image processing model to generate the GS frame.

According to a third aspect, an embodiment of this application provides an electronic device, including a processor and a memory that stores a computer program instruction. The processor executes the computer program instruction to implement the image processing method according to the first aspect.

According to a fourth aspect, an embodiment of this application provides a non-transitory computer-readable storage medium. The non-transitory computer-readable storage medium stores a computer program instruction. The computer program instruction, when executed by a processor, implements the image processing method according to the first aspect.

According to a fifth aspect, an embodiment of this application provides a computer program product, including a non-transitory computer-readable storage medium that contains computer-readable program code. The computer-readable program code in the computer program product, when executed by a processor of an electronic device, causes the electronic device to perform the image processing method according to the first aspect.

It can be learned from the foregoing content that in the embodiments of this application, spatial-temporal implicit encoding, exposure time embedding, and pixel-by-pixel decoding are performed on a blurred RS frame through the image processing model to recover clear GS frames from the blurred RS frame. The image processing model integrates the following three tasks for processing the RS frame into a unified process: RS frame correction, deblurring, and frame interpolation. This reduces cumulative errors and artifacts caused by separately performing the three tasks for processing the RS frame, to improve clarity and quality of the recovered GS frames. In addition, in the embodiments of this application, the RS frame is represented using an STIR to provide a comprehensive spatiotemporal context for the recovery from the RS frame. Exposure time embedding optimizes a temporal information representation of the RS frame, to improve the clarity of the GS frames. Pixel-by-pixel decoding can ensure accuracy of the GS frames obtained after decoding, to further improve the quality of the GS frames.

It can be learned that the solution provided in the embodiments of this application can improve the clarity of the GS frames recovered from the RS frame.

### BRIEF DESCRIPTION OF THE DRAWINGS

To describe the technical solutions in the embodiments of this application more clearly, the following briefly describes the accompanying drawings required for the embodiments of this application. A person of ordinary skill in the art may still derive other drawings from these accompanying drawings without creative efforts.

FIG. 1 is a schematic flowchart of an image processing method according to an embodiment of this application;

FIG. 2 is a schematic structural diagram of an image processing model according to an embodiment of this application;

FIG. 3 is a schematic diagram of a framework for implementing exposure time embedding by a time embedding unit according to an embodiment of this application;

FIG. 4 is a schematic diagram of a framework for implementing pixel-by-pixel decoding by a decoding unit according to an embodiment of this application;

FIG. 5 is a schematic diagram of training an image processing model according to an embodiment of this application;

FIG. 6 is a schematic diagram of visualized results of an experiment on a GevRS-Long Exposure dataset according to an embodiment of this application;

FIG. 7 is a schematic diagram of visualized results of an experiment on a GevRS-Real World dataset according to an embodiment of this application;

FIG. 8 is a schematic diagram of visualized results of an experiment on a Fastec dataset according to an embodiment of this application;

FIG. 9 is a schematic diagram of visualized results of an experiment on a Gev-RS dataset according to an embodiment of this application;

FIG. 10 is a schematic structural diagram of an image processing apparatus according to another embodiment of this application;

FIG. 11 is a schematic structural diagram of an electronic device according to still another embodiment of this application;

FIG. 12 is a schematic structural diagram of an encoding module according to another embodiment of this application; and

FIG. 13 is a schematic structural diagram of a data embedding module according to another embodiment of this application.

### DETAILED DESCRIPTION

Features of various aspects and exemplary embodiments of this application are described below in detail. To make the objectives, technical solutions, and advantages of this application clearer, this application is further described in detail below with reference to the accompanying drawings and embodiments. It should be understood that the embodiments described herein are merely used to explain this application, rather than to limit this application. A person skilled in the art can implement this application without some of these specific details. The following description of the embodiments is intended only to provide a better understanding of this application by illustrating examples of this application.

It should be noted that relational terms herein such as first and second are merely used to distinguish one entity or operation from another entity or operation without necessarily requiring or implying any actual such relationship or order between such entities or operations. In addition, terms “include”, “comprise”, or their any other variations are intended to cover a non-exclusive inclusion, such that a process, a method, an article, or a device that includes a series of elements not only includes those elements, but also includes other elements that are not explicitly listed, or also includes inherent elements of the process, the method, the article, or the device. Without more restrictions, the elements defined by the sentence “including . . . ” do not exclude the existence of other identical elements in a process, method, article, or device including the elements. The term “a plurality of” means two or more.

For ease of understanding, before the solution provided in this application is described, the background of the solution provided in this application is described first.

In the prior art, in a process of recovering clear GS frames from a blurred RS frame, correction, deblurring, and frame interpolation are usually performed on the RS frame as independent tasks, and cascaded through existing image enhancement networks. This approach increases cumulative errors and noticeable artifacts. For example, simply cascading a frame interpolation network and an RS frame correction network reduces clarity of the GS frames. Although an event camera method in the prior art features high spatiotemporal resolution, it cannot recover clear GS frames at an arbitrary frame rate from a single blurred RS frame. In addition, it has performance limitations in handling RS frame distortion, motion blur, and temporal discontinuity.

To resolve the problems in the prior art, the embodiments of this application provide an image processing method and apparatus, a device, a storage medium, and a computer program product. The following first describes the image processing method provided in the embodiments of this application.

In the image processing method provided in the embodiments of this application, clear GS frames at an arbitrary frame rate can be recovered from a blurred RS frame, and position coordinates and time coordinates are directly mapped to color values by leveraging high spatiotemporal resolution of an event camera and employing a spatial-temporal implicit neural representation technology (INR), to effectively address intertwined degradation (namely, image degradation due to combined impact of RS frame distortion and blur) in an image recovery process. The method mainly processes the RS frame in three aspects: spatial-temporal implicit encoding, exposure time embedding, and pixel-by-pixel decoding. The method provided in the embodiments of this application is significantly superior to the prior art by virtue of its lightweight model (with only 0.379 M parameters) and high efficiency (an inference speed of 2.83 ms/frame at 31× frame interpolation), and provides a unified and efficient solution for image processing tasks such as RS frame correction, deblurring, and frame interpolation.

The following describes an implementation process of the method provided in the embodiments of this application.

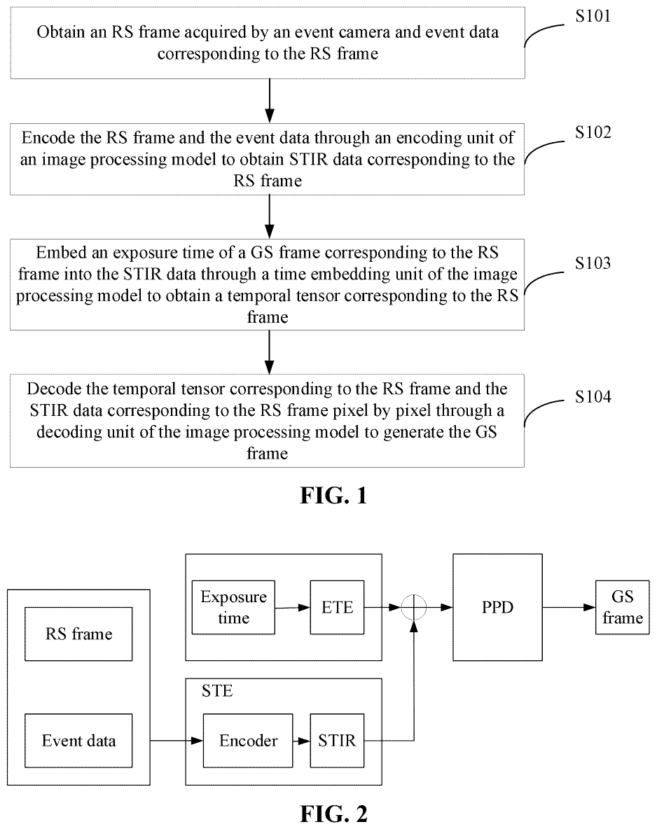

FIG. 1 is a schematic flowchart of an image processing method according to an embodiment of this application. As shown in FIG. 1, the method includes the following steps.

S101: Obtain an RS frame acquired by an event camera and event data corresponding to the RS frame.

In step S101, the event camera is a camera that acquires an image through a dynamic vision sensor. The event camera may acquire an “event” (namely, the event data) in an image generation process, for example, a change in pixel brightness.

In addition, in the embodiments of this application, a shutter is a mechanism used by a camera to control an effective exposure time of an image sensor. An RS frame is an image obtained by performing row-by-row scanning and exposure through a sensor in the camera until all pixels are exposed. A GS frame is an image generated by exposing an entire scene simultaneously. Through the method provided in the embodiments of this application, clear GS frames can be recovered from a blurred RS frame.

S102: Encode the RS frame and the event data through an encoding unit of an image processing model to obtain STIR data corresponding to the RS frame.

In step S102, the image processing model includes the encoding unit, a time embedding unit, and a decoding unit. The encoding unit is configured to encode the RS frame acquired by the event camera and the event data corresponding to the RS frame, to obtain an STIR of the RS frame.

In an embodiment, the encoding unit may perform multi-scale feature extraction on the RS frame and the event data corresponding to the RS frame, to better capture spatial-temporal information of the RS frame and the event data corresponding to the RS frame at different scales. This enhances the image processing model's ability to capture details and a global structure in the RS frame, to provide a basis for improving clarity of GS frames.

S103: Embed an exposure time of a GS frame corresponding to the RS frame into the STIR data through the time embedding unit of the image processing model to obtain a temporal tensor corresponding to the RS frame.

In step S103, the exposure time of the GS frame is duration from the start of exposure to the end of exposure of the GS frame.

In the embodiments of this application, the exposure time of the GS frame may be determined by a user based on an expected frame rate of GS frames. The exposure time of the GS frame is embedded into the STIR data to obtain a temporal tensor matching dimensions of the STIR data. The temporal tensor can reflect impact of different exposure times on clarity of the RS frame.

S104: Decode the temporal tensor corresponding to the RS frame and the STIR data corresponding to the RS frame pixel by pixel through the decoding unit of the image processing model to generate the GS frame.

In step S104, the STIR data may be decoded pixel by pixel based on the temporal tensor through a multilayer perceptron (MLP). The MLP enables the decoding module to adaptively focus on a key region of an image, to further improve quality of a recovered image while maintaining high decoding efficiency.

Based on the solution defined by steps S101 to S104, it can be learned that in the embodiments of this application, spatial-temporal implicit encoding, exposure time embedding, and pixel-by-pixel decoding are performed on a blurred RS frame through the image processing model to recover clear GS frames from the blurred RS frame. The image processing model integrates the following three tasks for processing the RS frame into a unified process: RS frame correction, deblurring, and frame interpolation. This reduces cumulative errors and artifacts caused by separately performing the three tasks for processing the RS frame, to improve clarity and quality of the recovered GS frames. In addition, in the embodiments of this application, the RS frame is represented using an STIR to provide a comprehensive spatiotemporal context for the recovery from the RS frame. Exposure time embedding optimizes a temporal information representation of the RS frame, to improve the clarity of the GS frames. Pixel-by-pixel decoding can ensure accuracy of the GS frames obtained after decoding, to further improve the quality of the GS frames.

It can be learned that the solution provided in the embodiments of this application can improve the clarity of the GS frames recovered from the RS frame.

The following further describes the implementation process of the method provided in the embodiments of this application.

In an embodiment, FIG. 2 is a schematic structural diagram of an image processing model. It can be learned from FIG. 2 that the image processing model mainly includes an encoding unit STE (STE is short for spatial-temporal implicit encoding), a time embedding unit ETE (ETE is short for exposure time embedding), and a decoding unit PPD (PPD is short for pixel-by-pixel decoding). The encoding unit STE is configured to encode a blurred RS frame and event data into an implicit representation capable of capturing spatial-temporal information, namely, STIR data. The time embedding unit ETE is configured to embed an exposure time of a GS frame into the STIR data, to provide an exposure time of each pixel. The decoding unit PPD is configured to combine the STIR data and the exposure time to generate a clear GS frame.

It should be noted that the RS frame is regarded as a row-wise combination of continuous GS frames within an exposure time such that a clear RS frame can be constructed row by row based on a series of clear GS frames. In the embodiments of this application, the image processing model may be represented by a function F(x, t, θ), which represents a mapping relationship between a pixel position, a timestamp, and a color value in the RS frame. x represents a position of each pixel in the RS frame. t represents an exposure timestamp of each pixel. θ is a parameter of the model. In the embodiments of this application, after a blurred RS frame I_{rsb} and event data E are input into the image processing model, the image processing model can output a series of clear GS frames at a high frame rate.

It can be learned from FIG. 2 that after the blurred RS frame I_{rsb} and the event data E are obtained, STIR data with a height of H, a width of W, and a feature dimension of C may be obtained by encoding the RS frame I_{rsb} and the event data E through an encoder in the encoding unit.

In an embodiment, feature extraction is performed on the RS frame and the event data through the encoding unit to obtain a spatial feature and a temporal feature corresponding to the RS frame. Then, sparse learning is performed on the spatial feature and the temporal feature corresponding to the RS frame through the encoding unit to obtain the STIR data corresponding to the RS frame.

In the foregoing embodiment, the encoding unit may have a sparse learning-based encoder architecture. In this scenario, spatial-temporal information during exposure of the RS frame is captured through the sparse learning-based encoder. This avoids computationally intensive optical flow estimation and improves data representation efficiency, to improve efficiency of the recovery from the RS frame.

In another embodiment, the encoding unit may be an encoder having a convolutional neural network (CNN). In this scenario, feature extraction is performed on the RS frame and the event data through a convolutional layer of the CNN to obtain the spatial feature and the temporal feature corresponding to the RS frame.

It should be noted that in this embodiment, a standard or depthwise separable convolutional layer is substituted for the sparse learning-based encoder to perform feature extraction on the blurred RS frame and the event data. In this way, an existing efficient CNN architecture, such as MobileNet or EfficientNet, can be integrated to improve feature extraction efficiency and accuracy.

In another embodiment, the encoding unit may alternatively be an encoder having a graph neural network (GNN). In this scenario, feature extraction is performed on the RS frame and the event data through the GNN to obtain the spatial feature and the temporal feature corresponding to the RS frame.

It should be noted that considering an unstructured characteristic of the event data, in this embodiment of this application, the event data is processed through the GNN to better capture a spatiotemporal relationship between events and provide a basis for improving the clarity of the GS frames.

Further, after the STIR data is generated through encoding, exposure time embedding is performed on the STIR data through the time embedding unit to obtain the temporal tensor corresponding to the RS frame.

In an embodiment, the exposure time of the GS frame and a timestamp of the RS frame are first obtained. Next, a mapping relationship between the exposure time of the GS frame and the timestamp of the RS frame is established through the time embedding unit. Then, the exposure time of the GS frame is embedded into the STIR data based on the mapping relationship to obtain the temporal tensor corresponding to the RS frame.

In the foregoing embodiment, the timestamp is used to represent an exposure start time of the RS frame. The exposure time of the GS frame may be determined based on the frame rate of the GS frames that is expected by the user. That is, after the user inputs the expected frame rate of the GS frames, the GS frames at the frame rate can be recovered from the blurred RS frame through the method provided in the embodiments of this application. It can be learned that clear GS frames at an arbitrary frame rate can be recovered from a single blurred RS frame through the solution provided in the embodiments of this application.

In an example, the time embedding unit may embed the exposure time through an MLP. In this scenario, an embedding position corresponding to the exposure time of the GS frame is determined through the mapping relationship between the exposure time of the GS frame and the timestamp of the RS frame. Then, the exposure time of the GS frame is embedded into the embedding position through the MLP to obtain the temporal tensor corresponding to the RS frame.

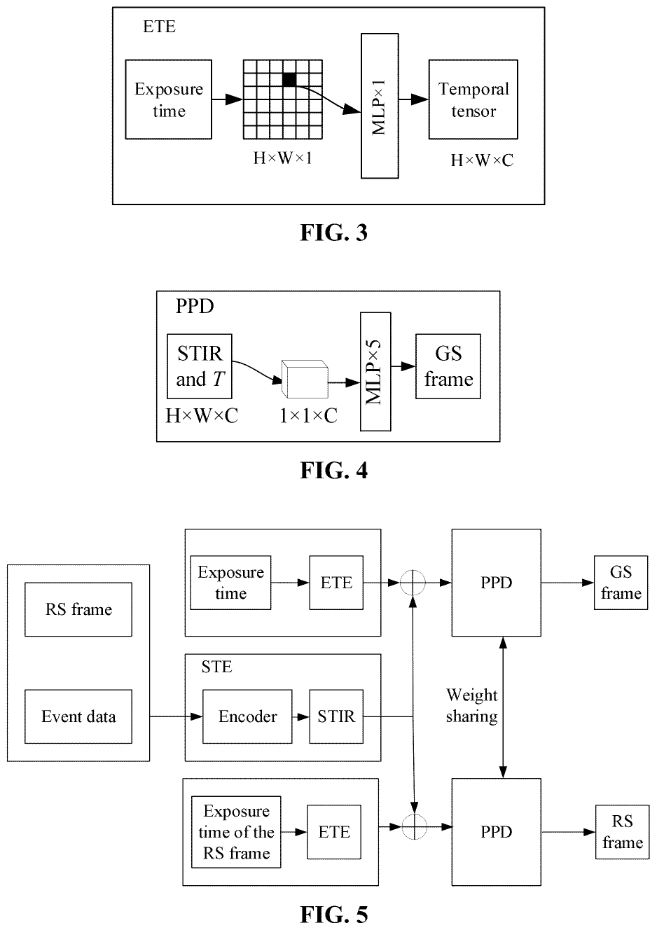

For example, FIG. 3 shows a framework for implementing exposure time embedding by the time embedding unit. It can be learned from FIG. 3 that the time embedding unit embeds an exposure time t_{g} of the GS frame into STIR data with dimensions H×W×1. A mapping is established between the exposure time of the GS frame and the timestamp of the RS frame, and then the dimensions are increased through a single-layer MLP (such as MLP×1 in FIG. 3), to effectively embed the exposure time. In this way, the temporal tensor matching the dimensions (H×W×C) of the STIR data can be generated.

In an embodiment, the exposure time of the GS frame may alternatively be embedded by dynamically adjusting an embedding manner. Specifically, a relationship between the timestamp and an exposure time embedding strategy is obtained, and a target embedding strategy corresponding to the timestamp is determined. Next, an embedding position corresponding to the exposure time is determined through the mapping relationship (namely, the mapping relationship between the exposure time of the GS frame and the timestamp of the RS frame). Then, the exposure time is embedded into the embedding position in the STIR data through the target embedding strategy to obtain the temporal tensor corresponding to the RS frame.

It should be noted that dynamically adjusting the exposure time embedding manner based on an input timestamp enables STIR data with the exposure time embedded to more accurately reflect impact of different exposure times, to improve the clarity of the GS frames.

It should also be noted that the foregoing exposure time embedding manner includes but is not limited to MLP-based embedding, periodic function embedding, and direct time encoding. For periodic function embedding, sine and cosine periodic functions may be used to encode the exposure time. Similar to positional encoding, it can effectively capture temporal periodicity and continuity. For direct time encoding, the exposure time may be directly used as input of the image processing model, but not converted through an embedding layer, to simplify a structure and training process of the image processing model.

Further, after the temporal tensor is obtained through exposure time embedding, pixel-by-pixel decoding is performed through the decoding unit to generate the clear GS frames. The decoding unit may implement pixel-by-pixel decoding through MLPs, or may implement pixel-by-pixel decoding through one or more of a generative adversarial network (GAN), a spatial transformer network (STN), or a deformable convolutional network (DCN).

In a scenario of implementing pixel-by-pixel decoding through MLPs, the decoding unit includes a plurality of MLPs. In this scenario, the temporal tensor corresponding to the RS frame and the STIR data corresponding to the RS frame are decoded pixel by pixel through the plurality of MLPs to obtain a GS frame corresponding to each exposure time of the RS frame.

In an example, FIG. 4 shows a framework for implementing pixel-by-pixel decoding by the decoding unit. It can be learned from FIG. 4 that the decoding unit performs decoding through a 5-layer MLP architecture with reference to the STIR data and the temporal tensor T to obtain the clear GS frames.

It should be noted that pixel-by-pixel decoding can eliminate a need for explicit positional queries and improve positional query efficiency, to improve GS data generation efficiency.

In a scenario of implementing pixel-by-pixel decoding through one or more of a GAN, an STN, or a DCN, the decoding unit includes one or more of a GAN, an STN, or a DCN. In this scenario, the temporal tensor corresponding to the RS frame and the STIR data corresponding to the RS frame are decoded pixel by pixel through one or more of the GAN, the STN, or the DCN to obtain a GS frame corresponding to each exposure time of the RS frame.

It should be noted that with a generator in a GAN architecture as a decoder, realism and details of the recovered image can be enhanced through adversarial training, to improve the clarity of the GS frames. Performing pixel-by-pixel decoding through the STN or the DCN can enhance the image processing model's ability to handle image spatial transformation, especially suitable for handling complex spatial deformation due to camera or object motion.

In an embodiment, the image processing model is obtained through training in following manners: First, RS frame sample data and a first RS frame corresponding to the RS frame sample data are obtained. Next, the RS frame sample data is input into an initial image processing model, and GS frames output by the initial image processing model are obtained. Then, a plurality of continuous GS frames are combined row by row to obtain a second RS frame, and feature comparison is performed on the first RS frame and the second RS frame to obtain feature difference data. Finally, a loss value of a loss function of the initial image processing model is calculated by using the feature difference data, and a parameter of the initial image processing model is adjusted based on the loss value until the loss function converges, to obtain the image processing model.

In the foregoing embodiment, the RS frame sample data includes at least an RS frame and event data corresponding to the RS frame. Clarity of the first RS frame is higher than clarity of the RS frame. The first RS frame is an average value of a plurality of RS frames generated by performing spatial-temporal implicit encoding, exposure time embedding, and pixel-by-pixel decoding on the RS frame and the event data. For example, FIG. 5 is a schematic diagram of training the image processing model. As shown in FIG. 5, an exposure time corresponding to the RS frame and an exposure time corresponding to the event data are embedded into STIR data through the time embedding unit. Next, decoding is performed through the decoding unit to obtain a plurality of clear RS frames corresponding to the RS frame sample data. Then, an average value of the plurality of clear RS frames is calculated to obtain the first RS frame. A process of generating the GS frames is the same as a process from steps S101 to S104, except that weight sharing is needed between two PPD units. After the plurality of continuous GS frames are obtained, the GS frames are combined row by row to obtain the second RS frame corresponding to the plurality of continuous GS frames. The first RS frame is compared with the second RS frame to determine recovery accuracy (represented by the feature difference data) of the RS frame. The parameter of the image processing model is adjusted based on the recovery accuracy to implement training of the image processing model.

It should be noted that the loss function in the training process of the image processing model may be determined by combining a blurred RS frame-guided integration loss with a reconstruction loss. The loss function can guide accurate recovery of RS frames and GS frames in a learning process of the image processing model.

It should also be noted that a manner of training the image processing model is not limited to the foregoing training manner. In practical application, the image processing model may alternatively be trained through adversarial training, transfer learning, or the like. For adversarial training, an adversarial training strategy may be introduced to further optimize performance of the image processing model through competitive learning, especially to obtain better effects on naturalness and detail recovery of a generated image. For transfer learning, a pre-trained model may be used as a part of an encoder or a decoder to adapt to specific image recovery tasks through transfer learning. This manner is suitable for an application scenario with a limited amount of data.

The loss function may be a perceptual loss function, an edge-preserving loss function, or the like. For the perceptual loss function, with a perceptual loss introduced, visual quality of a generated image can be improved by comparing feature-level differences instead of pixel-level differences. For the edge-preserving loss function, adding an edge-preserving loss term enhances the model's ability to recover edge and texture details, to improve clarity and a visual effect of an image.

The method provided in the embodiments of this application may be applied to fields such as video communication, media production, and digital entertainment. The following describes the method provided in the embodiments of this application by using three scenarios as examples.

In a first scenario, a clear video frame of an athlete or a vehicle captured during high-speed motion is recovered. In this scenario, the encoding unit may process a blurred RS frame and event data through a sparse learning-based encoder. The time embedding unit performs exposure time embedding through a single-layer MLP. The decoding unit performs pixel-by-pixel decoding through a 5-layer MLP to recover clear GS frames. The loss function is a loss function formed by combining the blurred RS frame-guided integration loss with the reconstruction loss. In this scenario, with a dataset of high-speed motion videos captured by a publicly available RS camera, a target frame rate is gradually increased from a low frame rate through progressive learning. When the RS frame acquired by the event camera is an RS frame of a vehicle during driving, a GS frame is generated through the method provided in the embodiments of this application. A lane may further be identified based on the GS frame to obtain a lane identification result. Then, the vehicle's driving is controlled based on the lane identification result.

In a second scenario, a clear video frame of nighttime cityscape is recovered in under low-light conditions. In this scenario, the encoding unit improves computational efficiency of the model and adapts to a feature extraction requirement under low-light conditions through a depthwise separable convolution. The time embedding unit dynamically adjusts an embedding strategy based on different exposure times through a dynamic time embedding network. The decoding unit improves detail quality of image recovery through an integrated attention mechanism. The loss function has the perceptual loss and the edge-preserving loss term added to enhance naturalness and clarity of a visual effect. In this scenario, with a dataset of RS videos specially acquired under low-light conditions, a pre-trained model is introduced to accelerate convergence of the model through transfer learning.

In a third scenario, during film production, a high-quality video frame is recovered from a shaky or fast-moving shot. In this scenario, the encoding unit uses a GNN-based encoder to better handle unstructured features of event data. The time embedding unit encodes an exposure time through a periodic function to capture temporal periodicity and continuity. The decoding unit uses a GAN-based generator as a decoder to enhance realism of a recovered image. The loss function uses a combined adversarial loss to optimize quality of a generated image. In this scenario, with a dataset of high-speed action scene videos obtained during film shooting, adversarial training is performed to optimize the performance of the model and improve realism and a visual effect of an image.

In the embodiments of this application, performance of the method provided in the embodiments of this application is further verified through verification experiments. Conditions of the verification experiments are mainly set from three aspects: a data augmentation strategy, training strategy optimization, and loss function refinement.

For the data augmentation strategy, in the verification experiments, high dynamic range event data is simulated to augment a training set. This makes the image processing model better adapt to image recovery tasks under different lighting conditions, to enhance the model's generalization ability.

For training strategy optimization, a progressive learning strategy is used. Training begins with recovering GS frames at a low frame rate, and a target frame rate is gradually increased. This helps stabilize a training process and improve performance of a final model.

For loss function refinement, a loss term based on structural similarity (SSIM) is added to a total loss function and appropriately weighted to ensure structural fidelity of a recovered image and further improve quality of the image.

During experimental verification, cross-domain verification is employed to conduct verification tests on datasets from a plurality of domains (such as street scenes, motion scenes, and indoor scenes) to ensure robustness and effects of the image processing model in different scenarios. During experimental verification, real-time performance tests are conducted under actual application conditions (such as embedded devices or mobile devices) to evaluate a processing speed and resource consumption of the image processing model, ensuring its suitability for real-time or near-real-time application scenarios.

In specific implementation, existing datasets such as a Gev-RS dataset and a Fastec-RSS dataset may be combined into new datasets as datasets in the experiments.

In the verification experiments, experiments are separately conducted on a Fastec dataset, the Gev-RS dataset, and a GevRS-Long Exposure dataset.

Results of the experiment on the Fastec dataset are shown in Table 1.

TABLE 1

| | | | Parameters | Peak signal-to- | | Learned perceptual image |
|---|---|---|---|---|---|---|
| Method | Frames | Event | (M) | noise ratio (PSNR) | SSIM | patch similarity (LPIPS) |
| DSUN | 2 | x | 3.91 | 26.52 | 0.79 | 0.122 |
| RSCD | 3 | x | 7.32 | 24.84 | 0.78 | 0.107 |
| SUNet | 2 | x | 11.91 | 28.34 | 0.84 | — |
| ESTRNN | 5 | x | 2.47 | 27.41 | 0.84 | 0.189 |
| JCD | 3 | x | 7.16 | 24.84 | 0.78 | 0.107 |
| RSSR | 2 | x | 26.04 | 21.23 | 0.78 | 0.166 |
| CVR | 2 | x | 42.69 | 28.72 | 0.85 | 0.111 |
| SelfUnroll-S | 1 | ✓ | — | 31.85 | 0.89 | 0.072 |
| SelfUnroll-M | 2 | ✓ | — | 32.34 | 0.90 | 0.084 |
| EvUnroll | 1 | ✓ | 20.83 | 31.32 | 0.88 | 0.061 |
| EvShutter | 1 | ✓ | — | 32.41 | 0.91 | 0.061 |
| UniNR | 1 | ✓ | 0.38 | 33.91 | 0.9234 | 0.049 |

M represents a quantity of parameters in millions. x represents “none”. ✓ represents “present”.

In Table 1, UniNR is the image processing method provided in the embodiments of this application. It can be learned from Table 1 that the method provided in the embodiments of this application uses fewer parameters and achieves a higher PSNR, higher SSIM, and lower LPIPS than the other methods. It can be learned that the image processing method provided in the embodiments of this application achieves a better experimental effect on the Fastec dataset than the other methods.

Results of the experiment on the Gev-RS dataset are shown in Table 2.

TABLE 2

| Method | Frames | Event | Parameters (M) | PSNR | SSIM | LPIPS |
|---|---|---|---|---|---|---|
| DSUN | 2 | x | 3.91 | 23.10 | 0.70 | 0.166 |
| JCD | 3 | x | 7.16 | 24.90 | 0.82 | 0.105 |
| EvUnroll | 1 | ✓ | 20.83 | 30.14 | 0.91 | 0.061 |
| NIRE | 1 | ✓ | — | 29.86 | 0.91 | — |
| UniNR | 1 | ✓ | 0.38 | 31.47 | 0.9327 | 0.038 |

It can be learned from Table 2 that the method provided in the embodiments of this application uses fewer parameters and achieves a higher PSNR, higher SSIM, and lower LPIPS than the other methods. It can be learned that the image processing method provided in the embodiments of this application achieves a better experimental effect on the Gev-RS dataset than the other methods.

Results of the experiment on the GevRS-Long Exposure dataset are shown in Table 3.

TABLE 3

| | | Input | | | Gev-RS-Blur | | Fastec-RS-Blur | |
|---|---|---|---|---|---|---|---|---|
| Method | | Frames | Event | M | PSNR | SSIM | PSNR | SSIM |
| 1× | JCD | 3color | x | 7.1659 | 19.42 | 0.6364 | 24.92 | 0.7422 |
| | EU | 1color | ✓ | 20.83 | 26.18 | 0.8606 | 29.76 | 0.8693 |
| | UniNR | 1color | ✓ | 0.3792 | 30.35 | 0.9714 | 33.64 | 0.9299 |
| 1× | esl-Net | 1 gray | ✓ | 0.1360 | 31.64 | 0.9614 | 32.45 | 0.9186 |
| | UniNR | 1 gray | ✓ | 0.3790 | 33.12 | 0.9881 | 34.62 | 0.9390 |
| 3× | EU + TL | 2color | ✓ | 93.03 | 21.86 | 0.7057 | 24.81 | 0.7179 |
| | UniNR | 1color | ✓ | 0.3792 | 28.36 | 0.9348 | 32.72 | 0.9147 |
| 5× | EU + TL | 2color | ✓ | 93.03 | 21.59 | 0.6964 | 24.46 | 0.7140 |
| | UniNR | 1color | ✓ | 0.3792 | 28.41 | 0.9062 | 32.13 | 0.9053 |
| 9× | EU + TL | 2color | ✓ | 93.03 | 21.24 | 0.6869 | 23.99 | 0.7029 |
| | UniNR | 1color | ✓ | 0.3792 | 27.21 | 0.8869 | 29.31 | 0.8590 |
| 3× | DeblurSR | 1gray | ✓ | 21.2954 | 17.64 | 0.554 | 21.17 | 0.5816 |
| | UniNR | 1gray | ✓ | 0.3790 | 31.11 | 0.9738 | 33.23 | 0.9210 |
| 5× | DeblurSR | 1gray | ✓ | 21.2954 | 18.35 | 0.6107 | 22.86 | 0.6562 |
| | UniNR | 1gray | ✓ | 0.3790 | 30.84 | 0.9673 | 32.82 | 0.9147 |
| 9× | DeblurSR | 1gray | ✓ | 21.2954 | 18.86 | 0.6502 | 23.96 | 0.7049 |
| | UniNR | 1gray | ✓ | 0.3790 | 30.54 | 0.9579 | 32.21 | 0.9051 |

EU represents EvUnroll. TL represents TimeLens. It can be learned from Table 3 that the method provided in the embodiments of this application uses fewer parameters and achieves a higher PSNR and higher SSIM than the other methods. It can be learned that the image processing method provided in the embodiments of this application achieves a better experimental effect on the GevRS-Long Exposure dataset than the other methods.

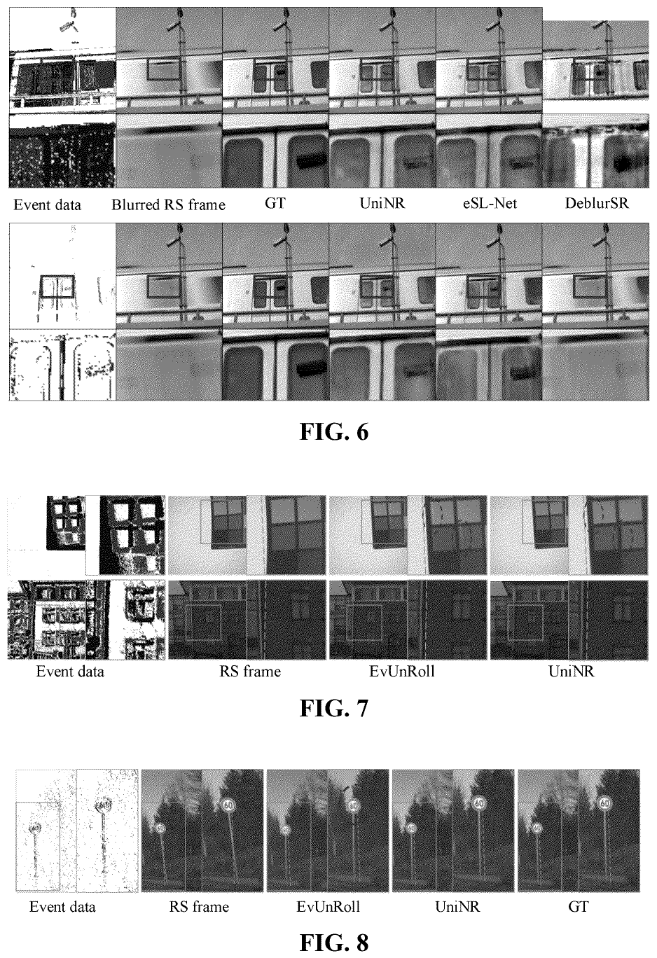

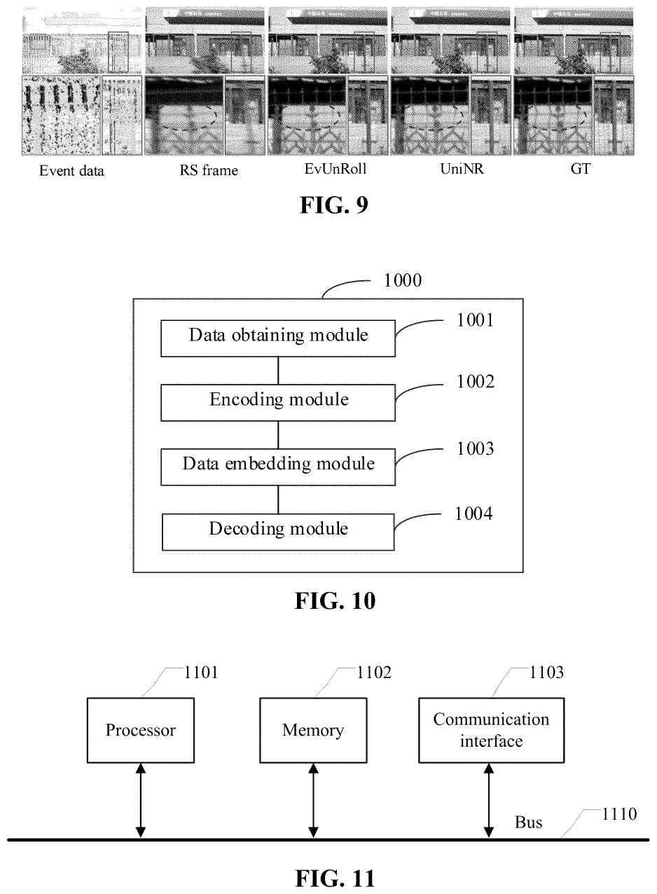

FIG. 6 shows visualized results of the experiment on the GevRS-Long Exposure dataset. FIG. 7 shows visualized results of an experiment on a GevRS-Real World dataset. FIG. 8 shows visualized results of the experiment on the Fastec dataset. FIG. 9 shows visualized results of the experiment on the Gev-RS dataset. It can be learned from the visualized results in FIG. 6 to FIG. 9 that the method provided in the embodiments of this application can provide clearer GS frames than the other methods.

It can be learned from the foregoing verification experiments and experiment results that the method provided in the embodiments of this application achieves significant progress and effects in technical, economic, and social aspects, which are specifically as follows:
(1) Unified processing of complex tasks: The method provided in the embodiments of this application can recover clear GS frames at an arbitrary frame rate from a single blurred RS frame, and effectively integrates the following three tasks into a unified process: RS frame correction, deblurring, and frame interpolation. The method breaks through and resolves a problem of cumulative errors and artifacts caused by separately performing these tasks in the prior art.
(2) Lightweight model and high efficiency: In comparison with the prior art, the model used in the method provided in the embodiments of this application has only 0.379 M (namely, 0.379 million) parameters, to significantly reduce a demand for computing resources. An inference speed of 2.83 ms/frame at 31× frame interpolation greatly improves a processing speed and makes real-time or near-real-time image processing applications possible.
(3) Superior performance: Extensive experimental verification demonstrates that the method provided in the embodiments of this application has significant performance advantages over the prior art in RS frame correction, deblurring, frame interpolation, and the like. Evaluation results on standard datasets show that the method provided in the embodiments of this application achieves significant improvements in both image quality metrics: PSNR and SSIM.
(4) Economic effect: The method provided in the embodiments of this application reduces dependence on high-performance computing resources through a lightweight model, to reduce computing costs of related image processing tasks. Especially for application scenarios requiring large-scale deployment, such as surveillance and autonomous driving, there is significant economic value. In addition, the method provided in the embodiments of this application has a high-efficiency processing capability such that a large amount of image data can be processed in a short time, to significantly improve production efficiency and accelerate a product development cycle.
(5) Social effect: Innovative application of the method provided in the embodiments of this application to the field of image processing advances development of RS frame correction and image enhancement technologies, playing a positive role in promoting technological progress and innovation in related scientific and technological fields. In addition, the method provided in the embodiments of this application can directly improve visual experience of end users by providing higher-quality image recovery results, especially in fields such as video communication, media production, and digital entertainment.

Finally, on standard test datasets, in comparison with the prior art, the method provided in the embodiments of this application achieves an average improvement of approximately 1.6 dB in PSNR and approximately 0.02 in SSIM compared, demonstrating significant improvements in image quality. For a 31× frame interpolation task, the method provided in the embodiments of this application achieves an inference speed approximately 60 times higher than that achieved by a traditional method, while maintaining high image recovery quality.

In summary, the method provided in the embodiments of this application achieves a technological breakthrough and has positive economic and social impact, significant application value, and broad development prospects.

The embodiments of this application further provide an image processing apparatus. As shown in FIG. 10, the apparatus 1000 includes a data obtaining module 1001, an encoding module 1002, a data embedding module 1003, and a decoding module 1004.

The data obtaining module 1001 is configured to obtain an RS frame acquired by an event camera and event data corresponding to the RS frame.

The encoding module 1002 is configured to encode the RS frame and the event data through an encoding unit of an image processing model to obtain STIR data corresponding to the RS frame.

The data embedding module 1003 is configured to embed an exposure time of a GS frame corresponding to the RS frame into the STIR data through a time embedding unit of the image processing model to obtain a temporal tensor corresponding to the RS frame.

The decoding module 1004 is configured to decode the temporal tensor corresponding to the RS frame and the STIR data corresponding to the RS frame pixel by pixel through a decoding unit of the image processing model to generate the GS frame.

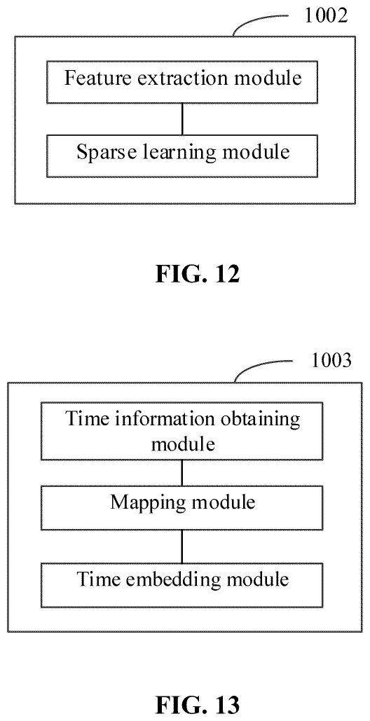

In an example, as shown in FIG. 12, the encoding module 1002 includes a feature extraction module and a sparse learning module. The feature extraction module is configured to perform feature extraction on the RS frame and the event data through the encoding unit to obtain a spatial feature and a temporal feature corresponding to the RS frame. The sparse learning module is configured to perform sparse learning on the spatial feature and the temporal feature corresponding to the RS frame through the encoding unit to obtain the STIR data corresponding to the RS frame.

In an example, the encoding unit includes a convolutional layer of a CNN. The feature extraction module is specifically configured to perform feature extraction on the RS frame and the event data through the convolutional layer to obtain the spatial feature and the temporal feature corresponding to the RS frame.

In an example, the encoding unit includes a GNN. The feature extraction module is specifically configured to perform feature extraction on the RS frame and the event data through the GNN to obtain the spatial feature and the temporal feature corresponding to the RS frame.

In an example, as shown in FIG. 13, the data embedding module 1003 includes a time information obtaining module, a mapping module, and a time embedding module. The time information obtaining module is configured to obtain the exposure time of the GS frame and a timestamp of the RS frame. The timestamp is used to represent an exposure start time of the RS frame. The mapping module is configured to establish a mapping relationship between the exposure time of the GS frame and the timestamp of the RS frame through the time embedding unit. The time embedding module is configured to embed the exposure time of the GS frame into the STIR data based on the mapping relationship to obtain the temporal tensor corresponding to the RS frame.

In an example, the time embedding unit includes an MLP. The time embedding module is specifically configured to determine an embedding position corresponding to the exposure time of the GS frame through the mapping relationship; and embed the exposure time of the GS frame into the embedding position through the MLP to obtain the temporal tensor corresponding to the RS frame.

In an example, the time embedding module is specifically configured to obtain a relationship between the timestamp and an exposure time embedding strategy, and determine a target embedding strategy corresponding to the timestamp; determine an embedding position corresponding to the exposure time through the mapping relationship; and embed the exposure time into the embedding position in the STIR data through the target embedding strategy to obtain the temporal tensor corresponding to the RS frame.

In an example, the decoding unit includes a plurality of MLPs. The decoding module is specifically configured to decode the temporal tensor corresponding to the RS frame and the STIR data corresponding to the RS frame pixel by pixel through the plurality of MLPs to obtain a GS frame corresponding to each exposure time of the RS frame.

In an example, the decoding unit includes one or more of a GAN, an STN, or a DCN. The decoding module is specifically configured to decode the temporal tensor corresponding to the RS frame and the STIR data corresponding to the RS frame pixel by pixel through one or more of the GAN, the STN, or the DCN to obtain a GS frame corresponding to each exposure time of the RS frame.

In an example, the image processing model is obtained through training in following manners: Obtain RS frame sample data and a first RS frame corresponding to the RS frame sample data, where the RS frame sample data includes at least an RS frame and event data corresponding to the RS frame, and clarity of the first RS frame is higher than clarity of the RS frame. Input the RS frame sample data into an initial image processing model, and obtain GS frames output by the initial image processing model. Combine a plurality of continuous GS frames row by row to obtain a second RS frame. Perform feature comparison on the first RS frame and the second RS frame to obtain feature difference data. Calculate a loss value of a loss function of the initial image processing model by using the feature difference data. Adjust a parameter of the initial image processing model based on the loss value until the loss function converges, to obtain the image processing model.

The present disclosure further provides another embodiment of the image processing apparatus. In this embodiment, the image processing apparatus includes a processor. The processor is configured to execute the following program modules and program units stored in a memory: the data obtaining module 1001, encoding module 1002, data embedding module 1003, decoding module 1004, feature extraction module, sparse learning module, time information obtaining module, mapping module, time embedding module, encoding unit, time embedding unit, and decoding unit.

The image processing apparatus provided in this embodiment of this application can implement each process implemented in the foregoing method embodiments. To avoid repetition, details are not described herein again.

Those skilled in the art should clearly understand that, for convenient and concise description, only the division of the above-mentioned functional units/modules is used as an example for illustration. In practical application, the above-mentioned functions may be realized by different functional units/modules as required, that is, the internal structure of the apparatus is divided into different functional units or modules to complete all or part of the above-described functions. The functional units/modules in the embodiments may be integrated into one processing unit, or each of the units may exist alone physically, or two or more units are integrated into one unit. The above integrated unit may be implemented either in a form of hardware or in a form of a software functional unit. In addition, specific names of the functional units/modules are only for the convenience of distinguishing each other, and are not intended to limit the protection scope of the present disclosure. For specific working processes of the units/modules in the above system, reference may be made to the corresponding processes in the above method embodiment, and details are not described herein again.

FIG. 11 is a schematic structural diagram of hardware of an electronic device according to an embodiment of this application.

Specifically, the electronic device may include a processor 1101 and a memory 1102 storing computer program instructions.

Specifically, the processor 1101 may include a central processing unit (CPU) or an Application Specific Integrated Circuit (ASIC), or may be configured as one or more integrated circuits for implementing the embodiments of this application.

The memory 1102 may include a mass memory for data or instructions. By way of example but not limitation, the memory 1102 may include a hard disk drive (HDD), a floppy disk drive, a flash memory, an optical disk, a magnetic disk, a magnetic tape, or a universal serial bus (USB) drive, or a combination of two or more of these. If appropriate, the memory 1102 may include a removable or non-removable (or fixed) medium. If appropriate, the memory 1102 may be inside or outside of an integrated gateway disaster recovery device. In a specific embodiment, the memory 1102 is a nonvolatile solid-state memory.

The memory may include a read-only memory (ROM), a random access memory (RAM), a disk storage media device, an optical storage media device, a flash memory device, or an electrical, optical, or another physical/tangible memory storage device. Thus, typically, the memory includes one or more tangible (non-transitory) computer-readable storage media (for example, a memory device) encoded with software that includes computer-executable instructions. When the software is executed (for example, by one or more processors), the operations described with reference to the method according to an aspect of the present disclosure may be performed.

The processor 1101 reads and executes computer program instructions stored in the memory 1102, to implement the image processing method according to any of the embodiments.

In an example, the electronic device may further include a communication interface 1103 and a bus 1110. As shown in FIG. 11, the processor 1101, the memory 1102, and the communication interface 1103 are connected through the bus 1110 to complete mutual communication.

The communication interface 1103 is mainly configured to implement the communication between the modules, devices, units, and/or equipment in the embodiments of this application.

The bus 1110 includes hardware, software, or both, to couple the components of the electronic device to each other. By way of example but not limitation, the bus may include an accelerated graphics port (AGP) or another graphics bus, an extended industry standard architecture (EISA) bus, a front-side bus (FSB), a hypertransport (HT) interconnect, an industry standard architecture (ISA) bus, an InfiniBand interconnect, a low pin count (LPC) bus, a memory bus, a microchannel architecture (MCA) bus, a peripheral component interconnect (PCI) bus, a PCI-Express (PCI-X) bus, a Serial Advanced Technology Attachment (SATA) bus, a Video Electronics Standards Association local bus (VLB), or another suitable bus or a combination of two or more of these. If appropriate, the bus 1110 may include one or more buses. Although specific buses are described and illustrated in the embodiments of this application, any suitable bus or interconnect may be used in this application.

In addition, an embodiment of this application provides a non-transitory computer-readable storage medium to implement the image processing method in the foregoing embodiments. The non-transitory computer-readable storage medium stores computer program instructions. When the computer program instructions are executed by a processor, the image processing method in the any of the foregoing embodiments is implemented.

In addition, an embodiment of this application provides a computer program product to implement the image processing method in the foregoing embodiments. The computer program product includes a non-transitory computer-readable storage medium containing computer-readable program code. When executed by a processor of an electronic device, the computer-readable program code in the computer program product causes the electronic device to perform any of the image processing methods described in the aforementioned embodiments.

It is to be clear that this application is not limited to the particular configuration and processing described above and illustrated in the accompanying drawings. A detailed description of the known method is omitted herein for the sake of brevity. In the above embodiments, several specific steps are described and illustrated as examples. However, the method of this application is not limited to the specific steps described and illustrated, and a person skilled in the art may make various changes, modifications and additions, or change the step sequence based on the spirit of this application.

The functional blocks shown in the structural block diagrams described above may be implemented as hardware, software, firmware, or a combination thereof. When implemented in hardware, the functional block may be, for example, an electronic circuit, an ASIC, appropriate firmware, a plug-in, a function card, or the like. When implemented in software, the elements of this application are programs or code segments that are used to perform the required task. The program or code segment may be stored in a machine-readable medium or transmitted on a transmission medium or communication link via a data signal carried in a carrier wave. A “machine-readable medium” may include any medium capable of storing or transmitting information. Examples of the machine-readable medium include an electronic circuit, a semiconductor memory device, a ROM, a flash memory, an erasable ROM (EROM), a floppy disk, a CD-ROM, an optical disk, a hard disk, a fiber optic medium, a radio frequency (RF) link, and the like. The code segment may be downloaded via computer networks such as the Internet or Intranets.

It is also noted that the exemplary embodiments mentioned in this application describe some methods or systems based on a series of steps or devices. However, this application is not limited to the above step sequence, that is, the steps may be performed in the sequence in the embodiments or in a sequence different from the sequence in the embodiments, or several steps may be performed simultaneously.

Various aspects of the present disclosure are described with reference to flowcharts and/or block diagrams of the image processing methods, devices, computer-readable storage media and computer program products according to embodiments of the present disclosure. It should be understood that each block of the flowcharts and/or block diagrams, and combinations of blocks in the flowcharts and/or block diagrams, can be implemented by the computer program instructions. The computer program instructions can be provided to a processor of a general-purpose computer, a dedicated computer, or other programmable data processing device, to produce a machine that makes the instruction when executed by the processor of the computer or other programmable data processing devices to implement the functions/actions specified in one or more blocks in the flowcharts and/or block diagrams. Such a processor may be, but is not limited to, a general purpose processor, an application specific processor, or a field programmable logic circuit. It should also be noted that each block in the flowcharts and/or block diagrams and combinations of the blocks in the flowcharts and/or block diagrams may be implemented by dedicated hardware for executing specified functions or operations, or may be implemented by a combination of dedicated hardware and computer instructions.

The foregoing descriptions are merely specific implementations of this application. A person skilled in the art can clearly understand that, for convenience and brevity of description, reference may be made to corresponding processes in the foregoing method embodiments for specific working processes of the foregoing systems, apparatuses, and units. Details are not described herein again. It should be understood that the protection scope of this application is not limited herein. Any equivalent modification or replacement readily figured out by a person skilled in the art within the technical scope disclosed in the present invention shall fall within the protection scope of the present invention.

1. An image processing method, comprising:
obtaining a rolling shutter (RS) frame acquired by an event camera and event data corresponding to the RS frame;
encoding the RS frame and the event data through an encoding unit of an image processing model to obtain spatial-temporal implicit representation (STIR) data corresponding to the RS frame;
embedding an exposure time of a global shutter (GS) frame corresponding to the RS frame into the STIR data through a time embedding unit of the image processing model to obtain a temporal tensor corresponding to the RS frame; and
decoding the temporal tensor corresponding to the RS frame and the STIR data corresponding to the RS frame pixel by pixel through a decoding unit of the image processing model to generate the GS frame.

2. The method according to claim 1, wherein the encoding the RS frame and the event data through an encoding unit of an image processing model to obtain STIR data corresponding to the RS frame comprises:
performing feature extraction on the RS frame and the event data through the encoding unit to obtain a spatial feature and a temporal feature corresponding to the RS frame; and
performing sparse learning on the spatial feature and the temporal feature corresponding to the RS frame through the encoding unit to obtain the STIR data corresponding to the RS frame.

3. The method according to claim 2, wherein the encoding unit comprises a convolutional layer of a convolutional neural network (CNN), and the performing feature extraction on the RS frame and the event data through the encoding unit to obtain a spatial feature and a temporal feature corresponding to the RS frame comprises:
performing feature extraction on the RS frame and the event data through the convolutional layer to obtain the spatial feature and the temporal feature corresponding to the RS frame.

4. The method according to claim 2, wherein the encoding unit comprises a graph neural network (GNN), and the performing feature extraction on the RS frame and the event data through the encoding unit to obtain a spatial feature and a temporal feature corresponding to the RS frame comprises:
performing feature extraction on the RS frame and the event data through the GNN to obtain the spatial feature and the temporal feature corresponding to the RS frame.

5. The method according to claim 1, wherein the embedding an exposure time of a GS frame corresponding to the RS frame into the STIR data through a time embedding unit of the image processing model to obtain a temporal tensor corresponding to the RS frame comprises:
obtaining the exposure time of the GS frame and a timestamp of the RS frame, wherein the timestamp is used to represent an exposure start time of the RS frame;
establishing a mapping relationship between the exposure time of the GS frame and the timestamp of the RS frame through the time embedding unit; and
embedding the exposure time of the GS frame into the STIR data based on the mapping relationship to obtain the temporal tensor corresponding to the RS frame.

6. The method according to claim 5, wherein the time embedding unit comprises a multilayer perceptron (MLP), and the embedding the exposure time of the GS frame into the STIR data based on the mapping relationship to obtain the temporal tensor corresponding to the RS frame comprises:
determining an embedding position corresponding to the exposure time of the GS frame through the mapping relationship; and
embedding the exposure time of the GS frame into the embedding position through the MLP to obtain the temporal tensor corresponding to the RS frame.

7. The method according to claim 5, wherein the embedding the exposure time of the GS frame into the STIR data based on the mapping relationship to obtain the temporal tensor corresponding to the RS frame comprises:
obtaining a relationship between the timestamp and an exposure time embedding strategy, and determining a target embedding strategy corresponding to the timestamp;
determining an embedding position corresponding to the exposure time through the mapping relationship; and
embedding the exposure time into the embedding position in the STIR data through the target embedding strategy to obtain the temporal tensor corresponding to the RS frame.

8. The method according to claim 1, wherein the decoding unit comprises a plurality of MLPs, and the decoding the temporal tensor corresponding to the RS frame and the STIR data corresponding to the RS frame pixel by pixel through a decoding unit of the image processing model to generate the GS frame comprises:
decoding the temporal tensor corresponding to the RS frame and the STIR data corresponding to the RS frame pixel by pixel through the plurality of MLPs to obtain a GS frame corresponding to each exposure time of the RS frame.

9. The method according to claim 1, wherein the decoding unit comprises one or more of a generative adversarial network (GAN), a spatial transformer network (STN), or a deformable convolutional network (DCN), and the decoding the temporal tensor corresponding to the RS frame and the STIR data corresponding to the RS frame pixel by pixel through a decoding unit of the image processing model to generate the GS frame comprises:
decoding the temporal tensor corresponding to the RS frame and the STIR data corresponding to the RS frame pixel by pixel through one or more of the GAN, the STN, or the DCN to obtain a GS frame corresponding to each exposure time of the RS frame.

10. The method according to claim 1, wherein the image processing model is obtained through training in following manners:
obtaining RS frame sample data and a first RS frame corresponding to the RS frame sample data, wherein the RS frame sample data comprises at least an RS frame and event data corresponding to the RS frame, and clarity of the first RS frame is higher than clarity of the RS frame;
inputting the RS frame sample data into an initial image processing model, and obtaining GS frames output by the initial image processing model;
combining a plurality of continuous ones of the GS frames row by row to obtain a second RS frame;
performing feature comparison on the first RS frame and the second RS frame to obtain feature difference data;
calculating a loss value of a loss function of the initial image processing model by using the feature difference data; and
adjusting a parameter of the initial image processing model based on the loss value until the loss function converges, to obtain the image processing model.

11. The method according to claim 2, wherein the image processing model is obtained through training in following manners:
obtaining RS frame sample data and a first RS frame corresponding to the RS frame sample data, wherein the RS frame sample data comprises at least an RS frame and event data corresponding to the RS frame, and clarity of the first RS frame is higher than clarity of the RS frame;
inputting the RS frame sample data into an initial image processing model, and obtaining GS frames output by the initial image processing model;
combining a plurality of continuous ones of the GS frames row by row to obtain a second RS frame;
performing feature comparison on the first RS frame and the second RS frame to obtain feature difference data;
calculating a loss value of a loss function of the initial image processing model by using the feature difference data; and
adjusting a parameter of the initial image processing model based on the loss value until the loss function converges, to obtain the image processing model.

12. The method according to claim 3, wherein the image processing model is obtained through training in following manners:
obtaining RS frame sample data and a first RS frame corresponding to the RS frame sample data, wherein the RS frame sample data comprises at least an RS frame and event data corresponding to the RS frame, and clarity of the first RS frame is higher than clarity of the RS frame;
inputting the RS frame sample data into an initial image processing model, and obtaining GS frames output by the initial image processing model;
combining a plurality of continuous ones of the GS frames row by row to obtain a second RS frame;
performing feature comparison on the first RS frame and the second RS frame to obtain feature difference data;
calculating a loss value of a loss function of the initial image processing model by using the feature difference data; and
adjusting a parameter of the initial image processing model based on the loss value until the loss function converges, to obtain the image processing model.

13. The method according to claim 4, wherein the image processing model is obtained through training in following manners:
obtaining RS frame sample data and a first RS frame corresponding to the RS frame sample data, wherein the RS frame sample data comprises at least an RS frame and event data corresponding to the RS frame, and clarity of the first RS frame is higher than clarity of the RS frame;
inputting the RS frame sample data into an initial image processing model, and obtaining GS frames output by the initial image processing model;
combining a plurality of continuous ones of the GS frames row by row to obtain a second RS frame;
performing feature comparison on the first RS frame and the second RS frame to obtain feature difference data;
calculating a loss value of a loss function of the initial image processing model by using the feature difference data; and
adjusting a parameter of the initial image processing model based on the loss value until the loss function converges, to obtain the image processing model.

14. The method according to claim 5, wherein the image processing model is obtained through training in following manners:
obtaining RS frame sample data and a first RS frame corresponding to the RS frame sample data, wherein the RS frame sample data comprises at least an RS frame and event data corresponding to the RS frame, and clarity of the first RS frame is higher than clarity of the RS frame;
inputting the RS frame sample data into an initial image processing model, and obtaining GS frames output by the initial image processing model;
combining a plurality of continuous ones of the GS frames row by row to obtain a second RS frame;
performing feature comparison on the first RS frame and the second RS frame to obtain feature difference data;
calculating a loss value of a loss function of the initial image processing model by using the feature difference data; and
adjusting a parameter of the initial image processing model based on the loss value until the loss function converges, to obtain the image processing model.

15. The method according to claim 6, wherein the image processing model is obtained through training in following manners:
obtaining RS frame sample data and a first RS frame corresponding to the RS frame sample data, wherein the RS frame sample data comprises at least an RS frame and event data corresponding to the RS frame, and clarity of the first RS frame is higher than clarity of the RS frame;
inputting the RS frame sample data into an initial image processing model, and obtaining GS frames output by the initial image processing model;
combining a plurality of continuous ones of the GS frames row by row to obtain a second RS frame;
performing feature comparison on the first RS frame and the second RS frame to obtain feature difference data;
calculating a loss value of a loss function of the initial image processing model by using the feature difference data; and
adjusting a parameter of the initial image processing model based on the loss value until the loss function converges, to obtain the image processing model.

16. The method according to claim 7, wherein the image processing model is obtained through training in following manners:
obtaining RS frame sample data and a first RS frame corresponding to the RS frame sample data, wherein the RS frame sample data comprises at least an RS frame and event data corresponding to the RS frame, and clarity of the first RS frame is higher than clarity of the RS frame;
inputting the RS frame sample data into an initial image processing model, and obtaining GS frames output by the initial image processing model;
combining a plurality of continuous ones of the GS frames row by row to obtain a second RS frame;
performing feature comparison on the first RS frame and the second RS frame to obtain feature difference data;
calculating a loss value of a loss function of the initial image processing model by using the feature difference data; and
adjusting a parameter of the initial image processing model based on the loss value until the loss function converges, to obtain the image processing model.

17. An image processing apparatus, comprising:
a data obtaining module configured to obtain a rolling shutter (RS) frame acquired by an event camera and event data corresponding to the RS frame;
an encoding module configured to encode the RS frame and the event data through an encoding unit of an image processing model to obtain spatial-temporal implicit representation (STIR) data corresponding to the RS frame;
a data embedding module configured to embed an exposure time of a global shutter (GS) frame corresponding to the RS frame into the STIR data through a time embedding unit of the image processing model to obtain a temporal tensor corresponding to the RS frame; and
a decoding module configured to decode the temporal tensor corresponding to the RS frame and the STIR data corresponding to the RS frame pixel by pixel through a decoding unit of the image processing model to generate the GS frame.

18. An electronic device, comprising: a processor and a memory that stores a computer program instruction; wherein
the processor executes the computer program instruction to implement the image processing method according to claim 1.

19. A non-transitory computer-readable storage medium, wherein the non-transitory computer-readable storage medium stores a computer program instruction, and the computer program instruction, when executed by a processor, implements the image processing method according to claim 1.

20. A computer program product, comprising: a non-transitory computer-readable storage medium that contains computer-readable program code, wherein the computer-readable program code in the computer program product, when executed by a processor of an electronic device, causes the electronic device to perform the image processing method according to claim 1.
